(19) United States
(12) Patent Application Publication
(10) Pub. No.: US 2006/0054024 A1
(43) Pub. Date: Mar. 16, 2006

(54) Device

(76) Inventor: Thomas M. Holmes, North Yorkshire (GB)

Correspondence Address: VENABLE LLP, P.O. BOX 34385, WASHINGTON, DC, 20045-9998, US

(21) Appl. No.: 10/986,830

(22) Filed: Nov. 15, 2004

(30) Foreign Application Priority Data
Sep. 16, 2004 (GB) 0420603.3

(51) Int. Cl. B01D 46/00

(52) U.S. Cl. 96/224

(57) ABSTRACT

An apparatus 2 for sterilising and fragrancing air, the apparatus 2 comprising an inlet 18, an outlet 11, a fragrance source 24 located between the inlet 18 and the outlet 11, and a fan 22, wherein the apparatus 2 further comprises an ultraviolet radiation source 26 located between the inlet 18 and the outlet 11.

The invention relates to an air fragrancing device. The invention relates particularly, but not exclusively, to an air fragrancing device that is objectionally operable to sterilise air passing through the device.

It is known that bad odours generally emanate from micro-organisms, for example, bacteria and mould. Air fragrancing devices do not destroy the micro-organisms, or prevent the initial build up or increase in their numbers. Such devices act to simply mask the bad odour.

Traditional air fragrancing devices, or “air fresheners” as they are commonly known, are used to mask unpleasant odours. However, the fragrance strength deteriorates over time, and the effectiveness of masking the odour is severely diminished. This is a particular problem in public washrooms which tend to have a pungent smell. In order to overcome this problem, it is common for a number of air fresheners to be used. However, the resultant fragrance is often overpowering for the users of the washroom.

It is an object of the present invention to provide an improved air fragrancing device.

According to a first aspect of the invention there is provided an apparatus for sterilising and fragrancing air, the apparatus comprising an inlet, an outlet, a fragrance source located between the inlet and the outlet, and a fan, wherein the apparatus further comprises an ultraviolet radiation source located between the inlet and the outlet.

In this arrangement, air exiting the apparatus is both sterilised and fragranced.

Preferably, the ultraviolet radiation source and the fragrance source lie adjacent one another, preferably, the ultraviolet radiation source is upstream of the fragrance source. This arrangement ensures that air drawn into the apparatus is firstly sterilised before being fragranced and exiting the apparatus. This ensures that the users of the washroom or similar location are provided with both sterilised and fragranced air.

Preferably, the inlet is located in a rear face of the apparatus.

Preferably, the ultraviolet radiation source is located adjacent the inlet. Advantageously, air entering the apparatus will immediately make contact with the ultraviolet radiation source thereby maximising the likelihood of airborne micro-organisms being killed or denatured. Preferably, the ultraviolet radiation source is a UV-C germicidal tube. Such tubes are known to be highly effective at breaking down and killing micro-organisms.

Preferably, the fragrance source is removably mounted in the apparatus. Advantageously, this allows the fragrance source to be easily removed and replaced when the fragrance has been used up without having to replace the entire apparatus. The costs to the user are therefore minimised. Further, servicing of the apparatus is made easier by being able to remove the fragrance source to allow an engineer access to, for example, the ultraviolet radiation source or fan.

Preferably, the fan is adjacent the outlet. This ensures that a continual airflow is drawn through the apparatus from the inlet and directed out of the outlet. More preferably, the fan is downstream of the fragrance source.

Preferably, the fan has an airflow equal to approximately allow one cycle of air change per hour within the environment to be sterilised and fragranced. This allows for effective cleansing of the air because the flow rate is such that the air passes over the ultraviolet radiation source slow enough to enable the effective sterilisation of the air.

Preferably, the apparatus has a cover portion, preferably, the cover portion is adapted to be secured to a remainder of the apparatus with a push-fit fitting. The cover portion protects the ultraviolet radiation source, the fragrance source, the fan and other components from being damaged. More preferably, the cover portion is moulded to be aesthetically pleasing to the user of a washroom, for example, having a number of ribs or raised arches moulded into the cover portion.

Preferably, the outlet is located in the cover portion. This enables an engineer to readily gain access to the outlet should it become blocked.

Preferably, the outlet comprises a number of apertures. Preferably, the inlet comprises a number of apertures. Preferably, the cumulative area of the apertures in the outlet is preferably less than the cumulative area of the apertures in the inlet. More preferably, the cumulative area of the apertures in the outlet is approximately equal to half the cumulative area of the apertures in the inlet. In this configuration, the airflow velocity increases as the air flows through the apparatus. This results in an increase in the movement of fragranced particles out of the apparatus. The mesh forming the apertures in the inlet or the outlet further acts as a guard to prevent objects falling into the apparatus.

Preferably, a shielding portion is provided to shield the ultraviolet radiation source. Advantageously, the shielding portion acts to protect said ultraviolet radiation source and ensures that no direct UV light is emitted from the apparatus. More preferably, the shielding portion has an opening. The opening is preferably located adjacent the fragrance source to allow sterilised air flowing from the ultraviolet source to be directed immediately to the fragrance source.

Preferably, the apparatus is attached to a support surface by spacing means. Advantageously, this arrangement allows air to be drawn behind the apparatus and through the inlet.

According to a third aspect of the invention there is provided a method of sterilising and fragrancing an environment comprising the steps of;
1. passing an airflow over an ultraviolet radiation source to produce a sterilised airflow,
2. passing the sterilised airflow over a fragrance source, and
3. directing the fragranced and sterilised airflow into the environment.

All of the features described herein may be combined with any of the above aspects; in any combination.

An embodiment of the invention will now be described, by way of example only, with reference to the accompanying drawings, wherein:

FIG. 1 is a schematic perspective view of an embodiment of an apparatus according to the invention;

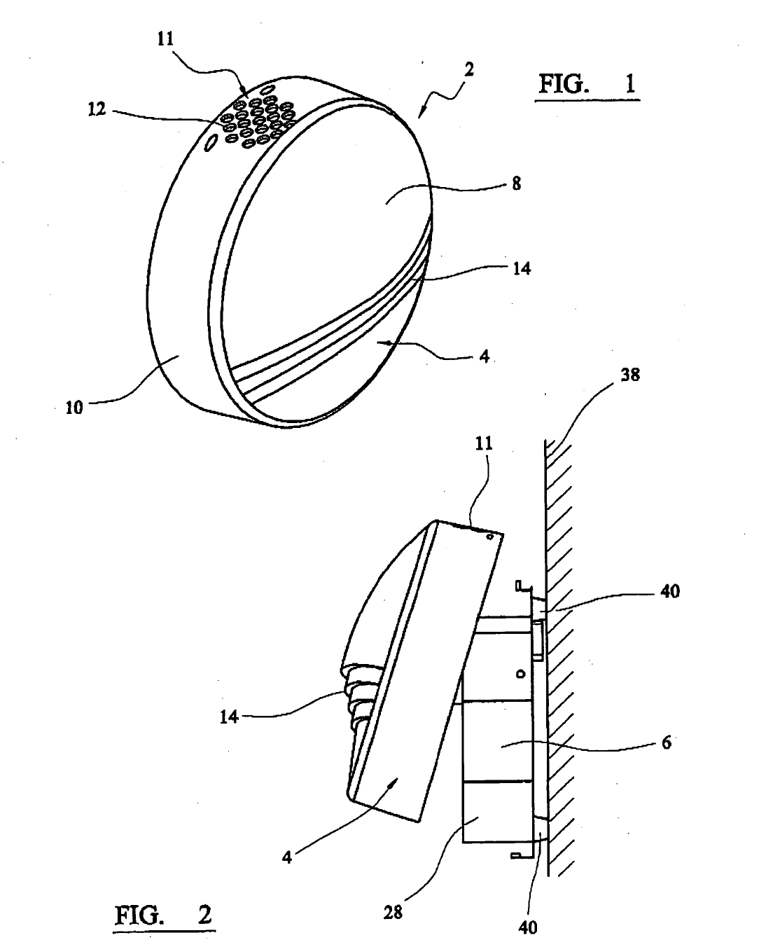

FIG. 2 is a schematic partially exploded side view of the apparatus of FIG. 1;

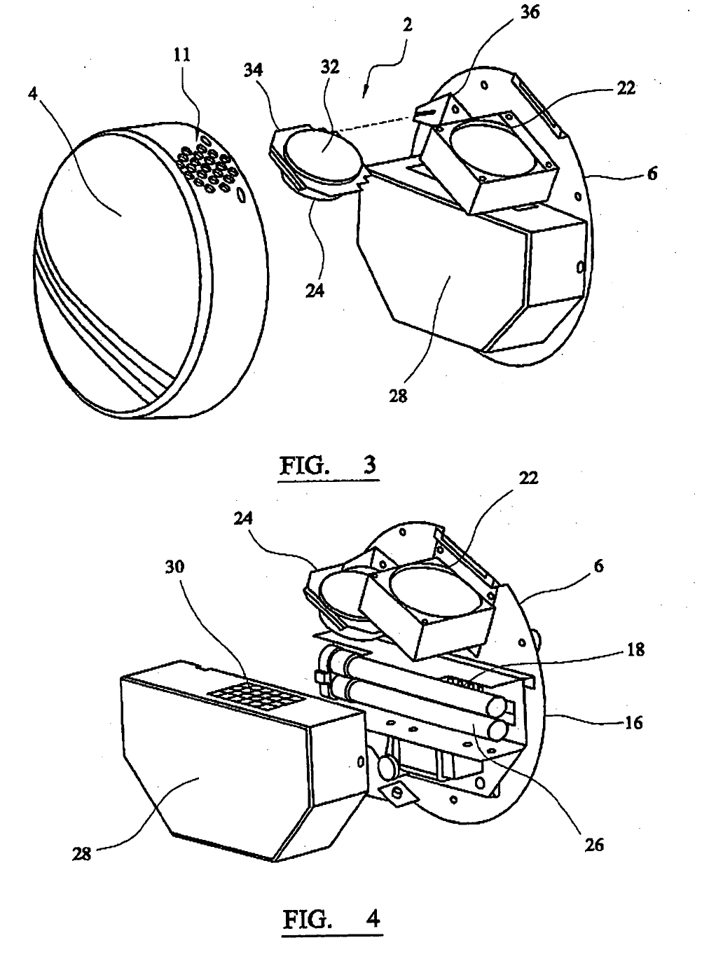

FIG. 3 is an exploded schematic perspective view of the apparatus of FIG. 1;

FIG. 4 is an exploded partial schematic view of the apparatus of FIG. 1;

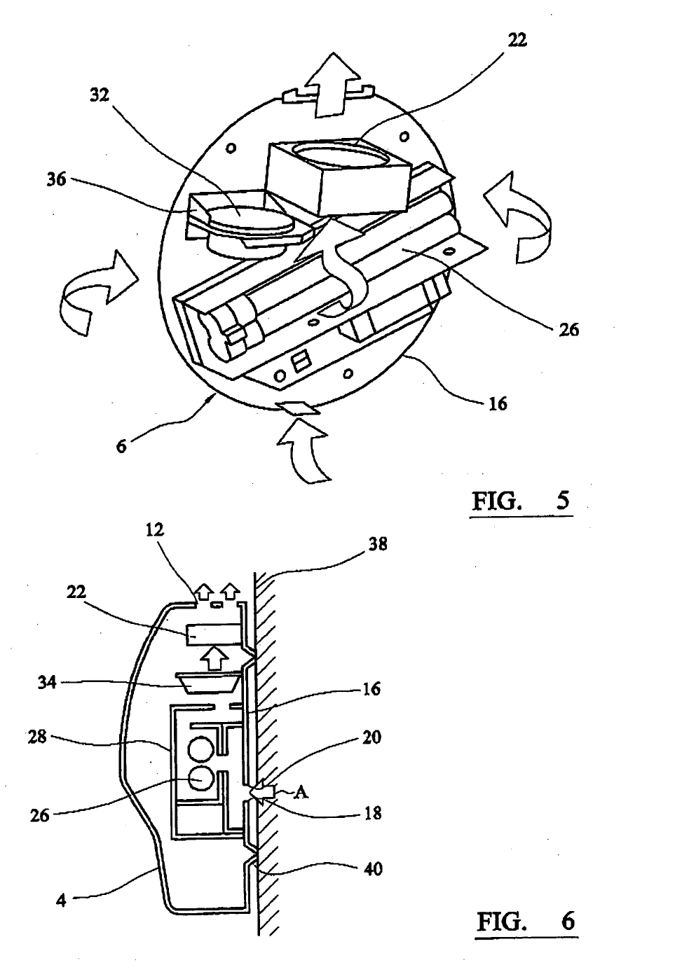

FIG. 5 is a schematic partial front view of the apparatus of FIG. 1; and

FIG. 6 is a schematic sectional side view of the apparatus of FIG. 1.

FIG. 1 shows an embodiment of an apparatus 2 according to the present invention. The apparatus 2 comprises a cover portion 4 that is generally circular in cross section being shaped to fit over a body 6 of the apparatus 2. The cover portion 4 has a face 8 and a circumferential wall 10. Ribs 14 are provided in the face 8 of the cover portion 4 to enhance the visual appeal of the apparatus 2.

An outlet 11 is located at an upper side of the circumferential wall 10. The outlet 11 comprises a number of circular apertures 12. Twenty-one apertures 12 are shown and are arranged in a generally diamond-shaped formation. However, it will be apparent to the skilled reader that any suitable number of apertures 12 may be provided, in a number of different arrangements, to enable the object of the invention to be achieved.

FIGS. 2 and 3 show the body 6 of the apparatus 2. The body 6 comprises a back portion 16 which is generally circular in plan being shaped to receive the cover portion 4. The back portion 16 has an inlet 18 located thereon. The inlet 18 comprises a number of apertures 20 which are arranged in a similar configuration to the apertures 12.

A fan assembly 22, a fragrance source 24 and an ultraviolet radiation source 26 are mounted on the back portion 16. A shielding member 28 fits over the ultraviolet radiation source 26 to prevent ultraviolet light from being emitted directly from the apparatus 2. A grill 30 in the shielding member 28 directs ultraviolet light towards the fragrance source 24. The ultraviolet radiation source 26 shown in the figures comprises two UV-C germicidal tubes but it will be appreciated by the skilled reader that other suitable ultraviolet sources may be used.

The fragrance source 24 comprises a fragrance tub 32 and a cartridge 34. The fragrance tub 32 comprises a block of perfume which fits into the cartridge 34 and is removable by upturning the cartridge 34. The fragrance source 24 is held in position on the back portion 16 by a bracket assembly 36.

The apparatus 2 is shown mounted to a support surface 38. The support surface 38 may be a wall or a ceiling. The apparatus 2 is mounted on stand offs or feet 40, through which screws hold the apparatus 2 in place. The feet 40 space the apparatus 2 from the support surface 38.

In use, air is drawn into the apparatus 2 by the fan assembly 22 and guided through the inlet apertures 12 as shown in FIGS. 5 and 6. The fan assembly 22 has an airflow equal to approximately allow one cycle of air change per hour within the environment to be sterilised and fragranced. The air is directed through a labyrinth towards the ultraviolet radiation source 26 as indicated by arrow A on FIG. 6. The air then passes over the ultraviolet radiation source 26 thereby killing or denaturing any airborne micro-organisms contained in the airflow. The now sterilised air flows past the fragrance source 24, taking up any perfume particles in the airflow path. The fragranced and sterilised airflow is directed towards the outlet 11. The velocity of the airflow increases as it exits the apparatus 2 due to the small cumulative area of outlet apertures 20. The air exiting the apparatus 2 is ejected back into the environment.

Over a period of time the fragrance source 24 will be depleted. In order to replace the fragrance source 24, the cartridge 34 is slid away from the bracket assembly 36. The cartridge 34 is turned upside down and the fragrance tub 32 tapped out. A new fragrance tub 32 is then slotted into the cartridge 34 and the cartridge 34 replaced in the bracket assembly 36.

The combination of using an ultraviolet radiation source and a fragrance source enables air in a local environment to be both sterilised and fragranced. The apparatus teaches away from the common method of using air fresheners to mask odours. Conversely, the apparatus acts on the source of the odour, micro-organisms and bacteria. In this manner, there is provided a continual disinfecting of the air as it passes through the device.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An apparatus for sterilising and fragrancing air, the apparatus comprising an inlet, an outlet, a fragrance source located between the inlet and the outlet, and a fan, wherein the apparatus further comprises an ultraviolet radiation source located between the inlet and the outlet.

2. Apparatus as claimed in claim 1, wherein the ultraviolet radiation source and the fragrance source lie adjacent one another.

3. Apparatus as claimed in claim 2, wherein the ultraviolet radiation source is upstream of the fragrance source.

4. Apparatus as claimed in claim 1, wherein the inlet is located in a rear face of the apparatus.

5. Apparatus as claimed in claim 1, wherein the ultraviolet radiation source is located adjacent the inlet.

6. Apparatus as claimed in claim, wherein the ultraviolet radiation source is a UV-C germicidal tube.

7. Apparatus as claimed in claim 1, wherein the fragrance source is removably mounted in the apparatus.

8. Apparatus as claimed in claim 1, wherein the fan is adjacent the outlet.

9. Apparatus as claimed in claim 8, wherein the fan is downstream of the fragrance source.

10. Apparatus as claimed in claim 8, wherein the fan has an airflow equal to approximately allow one cycle of air change per hour within the environment to be sterilised and fragranced.

11. Apparatus as claimed in claim 1, wherein the apparatus has a cover portion.

12. Apparatus as claimed in claim 11, wherein the cover portion is adapted to be secured to a remainder of the apparatus with a push-fit fitting.

13. Apparatus as claimed in claim 11, wherein ribs are moulded in a surface of the cover portion.

14. Apparatus as claimed in claim 11, wherein the outlet is located in the cover portion.

15. Apparatus as claimed in claim 1, wherein the outlet comprises a number of apertures.

16. Apparatus as claimed in claim 1, wherein the inlet comprises a number of apertures.

17. Apparatus as claimed in claim 15, wherein the cumulative area of the apertures in the outlet is less than the cumulative area of the apertures in the inlet.

18. Apparatus as claimed in claim 15, wherein the cumulative area of the apertures in the outlet is approximately equal to half the cumulative area of the apertures in the inlet.

19. Apparatus as claimed in claim 1, wherein a shielding portion is provided to shield the ultraviolet radiation source.

20. Apparatus as claimed in claim 19, wherein the shielding portion has an opening located adjacent the fragrance source.

21. Apparatus as claimed in claim 1, wherein spacing means are provided to attach the apparatus to a support surface.

22. A method of sterilising and fragrancing an environment comprising the steps of:
1. passing an airflow over an ultraviolet radiation source to produce a sterilised airflow,
2. passing the sterilised airflow over a fragrance source, and
3. directing the fragranced and sterilised airflow into the environment.

23. (canceled)
